(19) United States
(12) Patent Application Publication
(10) Pub. No.: US 2016/0247152 A1
(43) Pub. Date: Aug. 25, 2016

(54) METHOD AND SYSTEM FOR IMPROVING SAVINGS THROUGH A PORTABLE MOBILE DEVICE OR INTERNET

(71) Applicant: Octavio NOVELO SEGURA, México, D.F. (MX)

(72) Inventor: Octavio Novelo Segura, Mexico, D.F. (MX)

(21) Appl. No.: 15/025,908

(22) PCT Filed: Sep. 29, 2014
(86) PCT No.: PCT/IB14/64937

§ 371 Date: Mar. 30, 2016

(30) Foreign Application Priority Data
Sep. 30, 2013 (MX) MX/A/2013/011404

(51) Int. Cl. G06Q 20/40; G06Q 20/42

(52) U.S. Cl. CPC G06Q 20/405; G06Q 20/42

(57) ABSTRACT

A method and system for increasing the personal savings rate of the general population, through a method or system which recognizes the payments or charges undertaken in real time through credit or debit cards of the user and from that initial purchase a secondary transaction is set off for an amount selected by the user to round off the amount of that purchase to the next unit, ten unit or hundred unit and sending that net amount minus commissions for the service of this secondary transaction to a savings or investment account of the user.

### CROSS-REFERENCE TO RELATED APPLICATIONS

This application is a United States national phase application based on PCT/IB2014/064937 filed Sep. 29, 2014, which claims the benefit of Mexican Patent Application No. MX/a/2013/011404 dated Sep. 30, 2013.

### FIELD OF THE INVENTION

The present invention refers to a method and to a system which allows increasing the personal savings rate for the general public and particularly it refers to a method and system to be used in internet or mobile devices such as smart telephones, personal tablets or similar with a network connection, such as could be the internet, which allows the user to send a rounded off payment to a savings account or to a predetermined investment each time a purchase or payment is undertaken with a consumer mobile device, such as a credit card or a debit card.

### BACKGROUND OF THE INVENTION

Saving money is generally a complicated task and saving for retirement is even more so, so that generally people tend to save little or not at all for their retirement.

In Mexico, more than 49 million individual retirement accounts are in existence at the savings retirement system (AFORE for its initials in Spanish), of which, as of June 2013 they totaled 1,873 billion Mexican pesos in deposits for the purposes of retirement, severance and old age (RCV for its initials in Spanish), in addition to voluntary savings for workers (hereinafter AV, for its initials in Spanish), where the retirement, severance and old age are the mandatory tripartite by law of the federal government contributions, the employers and the employees, whereas the voluntary savings are the contributions which each worker voluntarily can save to increase the balance or amount with which he/she can count on for retirement.

The voluntary savings amount represents less than 1% of savings of the system, that is to say, 15 billion of the total 1,873 billion in the system.

To paraphrase, each employee with an account in the AFORE system, has voluntarily saved the total amount of $313 pesos.

According to a study conducted by the National Savings Commission for Retirement Fund (from now on called CONSAR for its Spanish initials), 46% of workers declare saving some amount from their income; however this amount is generally not considered targeted for retirement purposes.

The average age for beginning to save for retirement purposes is 45 years of age.

When asked what the reasons are as to why people do not save, the response 85% of the time is “given insufficient income”, among other reasons mentioned are: “not interested”, “bank requirements”, “lack of information”, “do not know” and “the interest rates are low”.

Upon analyzing savings behavior and retirement savings in other countries of the world, it is surprising to see the patterns repeated.

In the United States of America for example, according to a study undertaken by the HRS in 1996, the average American saved less than 3% of his average income over the last ten years, and more than a third responded that they had not saved anything for their retirement.

According to the same study, 75% of respondents feel they had not saved sufficiently enough and declared that they would save at a higher rate if they could start over again, notwithstanding this declaration, only 1 out of 3 people who are currently employed, plan to save more than what they are currently saving.

Upon reaching retirement, 40% of Americans will have the same or a lesser amount of savings than what they had 10 years prior.

When asked why the small or null amount in savings, the most common reason given is the same as that proffered in Mexico, which is “low income”.

Following the results in this study, the average home with married couples whose average age is 56 years, will have to save 17% of their current income to allow retirement to occur at age 62 without having to change their consumer habits of their current lifestyle.

50% of Americans do not have a pension plan with an annuity.

80% of Americans between 30 and 54 years of age believe they do not have sufficient money for retirement purposes.

To date, there are only 42% of Americans aged between 25 and 64 who have a pension plan, juxtaposed to 50% who had one in 1979.

In 2012, 30% of Americans stated that they had less than 1,000 US dollars saved or invested for retirement purposes.

60% of the work force declared having less than 25,000 dollars saved for retirement after having subtracted their living expenses and their pension fund.

56% of people have not calculated the amount of money that they would have to save in order to retire in a dignified manner.

In conclusion, people tend to think short term and not long term and there is a generalized conception of not having the capability to save due to insufficient incomes.

The mobile consumer devices through both credit cards and debit cards, as well as on-line purchases continues growing and substituting cash as the form of payment.

At the close of 2012 approximately 3.3 billion credit and debit cards were in circulation on a world-wide level, of which 1.5 billion correspond to credit cards and 1.8 billion to debit cards.

The electronic payment system on a worldwide level has achieved the fact of spending money having become easier with time, in light of among others, the commercial advertisements which are constantly being made by business establishments with banking institutions to grant credit for the consumer, the promotion of impulse buying or cross sales, means that people tend to spend more easily via electronic means, with mobile consumer devices, than they would if spending cash.

As opposed to these advances and commercial innovations for promoting consumerism, saving by contrast, has not been the objective of commercial innovations to promote its increase, a proof of this is the reversal in the personal savings rate versus the revolving consumer credit rate as a percentage of disposable income of the population in the United States of America, which became inverted in a matter of 30 years, crossing each other since 1992, where the personal savings rate and the revolving consumer credit were 10% and 2% in 1981, whereas at the close of 2012, their respective levels were 4.7% and 7.5%.

When cash was handled with greater frequency on a day to day basis, saving money was much simpler, given that cash could physically be separated or “saved” and could easily be placed in a safety deposit box or a moneybox for example, with which people could store and not touch the cash for a certain amount of time or until reaching a specific amount or a special date.

In regards to this, the origin of the word “savings” as is used in English, comes precisely from the act of “saving” or “preserving” cash.

A common way of saving cash money used to be by means of saving change, that is, storing or separating the money remaining which represented the difference between the amount paid and the bill or total amount which the bill cost. From this practice and from natural price inflation, the concept of rounding-off developed commercially, which consists of rounding up or rounding down, more commonly rounding up, the total amount of a bill or a product to be purchased in order to avoid handling change between the parties. The rounding off is a common commercial practice in the majority of countries in the world.

In physical transactions, it is necessary when due to inflation; low denomination coins are being retired from circulation in a country, and given this, it is physically impossible to return the change for a purchase to the client when there are no coins of said denomination available.

In electronic transactions it is not necessary; however, it is commonly used as an administratively simplifying method as well as for the purposes of simplifying the counting method, as well as also being a mechanism to donate to non-profit organizations for example.

There is no such thing in the market which constantly reminds people of the importance of saving money for a special purpose at medium term or for retirement purposes, for example.

In regards to mobile telephones, at the close of 2012, there were over 6.8 billion mobile connections and around 3.5 billion mobile telephone individual users on a worldwide level. That is, one out of two people in the entire world are connected to a mobile telephone, and while this occurs, the mobile traffic data increases exponentially, where the mobile traffic data for 2012 is greater than that of all the prior years combined.

According to several studies, while it took sixteen years to sell the first billion smart telephones, it will only take three years to achieve selling the next billion smart phones.

The mobile technology ecosystem will add 10.5 billion dollars to the worldwide GDP from 2013 to 2017.

In this sense, electronic commerce continues to increase, while 17% of its sales in 2012 were transacted through a mobile device. At the close of 2013, it was estimated that it would increase to 37%.

### BRIEF DESCRIPTION OF THE INVENTION

The system and method described in present application allow the user to save from a checking account or a line of credit to another savings or investment account in a recurring and day-to-day manner, with the end goal that the user may be able to save and/or invest this money and not spend it.

This is achieved through a system connected to electronic accounts which are linked to the activity (activities) of the consumer mobile device(s) of the user.

The system detects each time the user undertakes an event, for example, undertakes a first transaction with a merchant to purchase or pay for a product or service with any of its consumer mobile device(s).

Once the system detects the amount of the first transaction with the merchant, the system must be capable of undertaking a secondary transaction or rounding off, to this end; it checks on its event configuration and sets off one of the following options prior to undertaking the secondary transaction: a) sends the user a request so that the user may select the amount of the secondary transaction or rounding off, b) sends the user a request so that the user may confirm the amount of the secondary transaction or round off previously determined for said event, or c) sends the user a notice confirming the amount and the secondary transaction or rounding off proof, which was previously determined for said event.

The secondary transaction or rounding off consists in the system generating an additional or secondary charge to the debit or credit card which set-off the event.

The additional or secondary charge is such an amount that it itself and the sum of the first account or payment are a whole amount, that is, there are no cents and can even be equivalent to a multiple of a particular number. Alternatively, the additional or secondary charge is such an amount that it itself and the sum of the event or first payment are a fractional amount, that is, with cents.

Thus, this rounding off has the capability of being for amounts which may vary from cents up to any possible amount according to that also previously decided by the user in the configuration of the request. This rounding off is always rounded up or rounded down, typically the rounding off can be to the nearest unit, nearest multiple of ten or one hundred or even to the immediately following cent multiple to 5, 10, 25, 50, 75 cents or to the units following 5, 10, 100 or 1,000 pesos or money units of the applicable country, for example 5, 10, 25, 50, 75 US cents or 1, 5, 10, 100 or 1,000 US dollars or 5, 10, 25, 50, 75 Euro cents or 1, 5, 10, 100 or 1,000 Euros.

Once having undertaken the secondary charge or rounding, the system transfers the amount of this transaction to the savings or investment account previously selected by the user.

The savings or investment account may be any type previously selected by the user which may have already existed or created specifically for the system intended for this purpose.

Similarly, the secondary or rounding off transaction, may be undertaken at that exact moment, weekly, monthly, having lapsed a period of time selected by the user or by specific instructions of the solely the user, with the rounding provided in the primary event sum within the period of time. Optionally, this step can already be previously predefined in the user's configuration.

In the method and system described by the present application, the user receives a notification of the secondary or rounding off transaction in his electronic mobile device via the system and/or an email and/or a handwritten message. However, it is possible that the user select not to receive this notification.

The user can then use the money in his/her savings or investment account according to how he/she predetermines it in the configuration of his/her account in the system, some examples of possible scenarios being: once a year, on a particular selected date, for example a birthday, wedding anniversary or a longer time frame, such as an additional account or alternative to his/her savings plan for retirement.

The user can check on the balance and transaction of his/her credit and/or debit card(s), as well as his/her savings and/or investment account(s) through the system in the user's electronic mobile device, through which the system additionally allows in a fast, simple and intuitive manner the ability to save money in a constant form, as well as allows the user to be more conscientious of his/her daily financial situation, through which improvement in the user's financial education and financial health system can be improved.

Another option is that the user may be able to select in the system configuration to allow a certain predetermined percentage be sent to savings as a function of the amount for which the purchase or payment has been undertaken, similar to a “tip” which the same user can send to savings each time a debit is posted.

With this method and system, the user can be confident that each time he/she spends money; he/she is also saving some of the money for himself/herself.

Among other alternatives, each time the user incurs in an expense an event is initiated that sets off any of the following actions, among others: (a) sending reminders without generating savings, (b) reading a message, such as SMS, sent by the bank as an event confirmation or as an alert stating the use of a consumer mobile device which sets off the disclosed method, (c) by means of a connection to an Application Programming Interface (API), such as, but not limited to, Four Square or Evernote, by means of “checkins”, sending a reminder of the event, or (d) when the event is performed in establishments wherein the user has a discount or is part of a loyalty or rewards program, sending the equivalent of the discount applied by the establishment to savings in accordance to the disclosed method.

Through this system, the user may also select the configuration to obtain a mixture of cents and percentages, depending on the category and the amount of the hill, for example, which could change the configuration of the request each time the user wishes.

The user can also set savings goals with different terms and for different purposes and can monitor the advancement of the same and publish it in his/her social networks or share it privately with those of his/her choosing. The user can also assign savings to the payment or prepayment of debts previously incurred by the user with the above mentioned benefits.

Through this method and system, saving money is not only easy and intuitive but is also fun and social.

Thus, the objective of the present invention is to provide a method and system through which an individual can easily accomplish saving each time the user carries out a payment or purchase through a consumer mobile device.

### BRIEF DESCRIPTION OF THE FIGURES

Other details and advantages of the invention will become clearer when upon reading the following detailed description together with the accompanying figures, of which:

FIG. 1 is a flow diagram of the general method according to one embodiment of the present invention.

FIG. 2 is a comparative rounding off chart, corresponding to the steps of selecting and confirming the rounding off and executing the rounding off order of FIG. 1, in which the system asks the user to select or confirm the predetermined rounding off option.

### DETAILED DESCRIPTION OF THE INVENTION

### Definitions

Electronic Mobile Device—Those electronic mobile devices which are mobile are preferred, which may include smart telephones, personal digital assistants (PDAs), tablets, personal computers and mobile personal computers, among others, where the electronic mobile device must have access to data systems.

Consumer Mobile Device—Devices which are mobile and compact are preferred in such a way that they are able to fit in a purse and/or consumer's pockets (such as for example, wallet size). These may include smart cards, credit or debit cards (with a magnetic strip and with or without a microchip), key devices (such as the Speedpass™, commercially available at Exxon-Mobil Corporation) etc. Other examples of consumer mobile devices include cellular phones, PDAs, personal locators, payment cards, security cards, access cards, Smart Media cards, transponders and similar. The consumer mobile devices may also be debit devices (for example, a debit card), credit devices (for example a credit device), or electronic wallet devices (for example an electronic wallet device).

Event—Any event which initiates the method of present invention, for example an action of purchasing or paying for some product or service with a consumer mobile device of the user and which sets off the beginning of the method of present invention. This is also identified as the initial charge.

Rounding off—Also identified as the secondary charge. The action undertaken by the system derived from an event through which the request undertakes a charge to the user's consumer mobile device for an amount such that the addition of the first charge amount and this secondary charge amount be such an amount with or without cents and even be equivalent to a determined multiple amount.

User—The user of the system, such as can be the actual person, persons or businesses which use the system and method of present invention. Examples of users of the system can be any natural person or legal entity that uses the consumer mobile device to undertake payments, using a consumer mobile device.

Merchant—Any entity, such as can be for example a store, restaurant, gas station, virtual or physical store, hotel, airline, etc., which accepts a credit or debit card(s) or any other type of electronic payment as a means of payment.

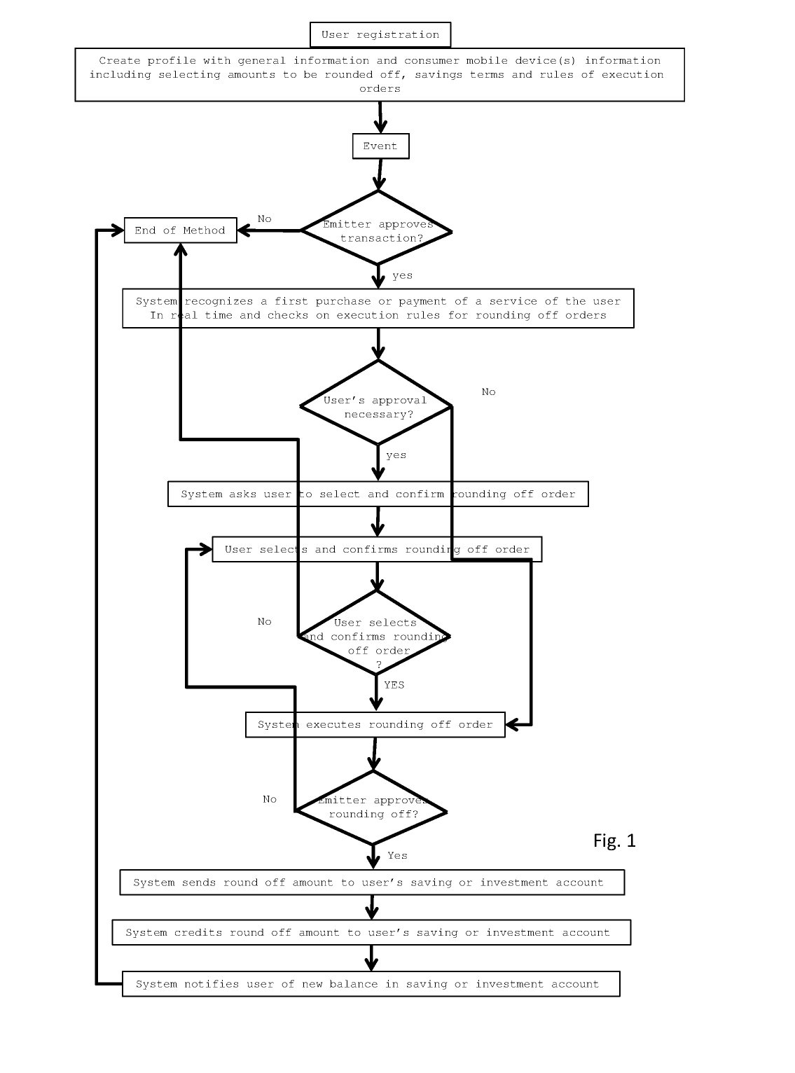

The following description is made in relation to FIG. 1.

When the user registers himself/herself, it is preferred that the user of the system of present invention, upload his/her personal information, such as name, address, email address, telephone number and numbers and passwords to at least one banking account with the end goal of linking said banking account to the system. Similarly, the user is required to input the data into his/her consumer mobile cell telephone(s).

Similarly, when inputting the data into the system, some adjustments may be chosen, such as could be a fixed or variable rounding off amount, or a percentage per each category and/or any of the variable which can be determined by the amount of each transaction or day of the week, for example, the user can change this selection at any moment by going to the request configuration. In one embodiment, the user can opt to not input this information and undertake the rounding off depending on the specific event. The user can elect the times or depending on certain events, receive or not receive notifications from the system. Similarly, in an embodiment, the user can choose needing or not needing a confirmation for the rounding off, that is, that the rounding off may be done automatically without the user's approval.

When a user uses a consumer mobile device with a merchant, the event is set-off, the system upon being connected to the movements of this consumer mobile device recognizes the charges and generates a request or rounding off order to the savings, through which it sends off or not, depending on what was chosen, an approval notification to the consumer mobile device of the user, asking him/her to choose or confirm the amount to be rounded off and which will then be charged to his/her consumer mobile device as another transaction or secondary bill, to later send this amount to his/her savings or investment account after the charges have been generated by the operation.

When the confirmation for the rounding off or secondary charges is undertaken, the system, just as it would with any other merchant, will undertake the consumer mobile device charge and send the remnant of the charged amount to the user's savings or investment account. In the situation where the user opted to not confirm the rounding off or secondary charge, then the method skips to the end without undertaking the rounding off or any charge whatsoever.

Upon confirming the charge of the rounding off on the user's behalf, an approval order is sent to the emitter. If the emitter disapproves the rounding off order, there are two options: return to the user selecting and confirming the rounding off order, or rather, end the process. If the emitter approves the rounding off order, the system sends the rounding off amount to the user's savings or investment account and afterwards, the system credits the rounding off amount to the user's savings or investment account. Finally, having credited the rounding off amount, the system can notify the user of the new balance in the user's savings or investment account.

The user can check up on the balance and transactions on his/her consumer mobile device, as well as in his/her savings and/or investment account through the electronic mobile device system, through which the system in addition to allowing him/her to save money in a constant manner in a fast, simple and intuitive way, also allows him/her to be more conscientious of his/her daily financial situation through which an improvement in financial health and education of the user of the system, can be expected.

The user's savings or investment account can be operated through a third party or can also be an account created expressly by the system. The balance in the user's savings or investment account could, optionally, generate different interest or yield levels according to the risk profile and/or the investment product portfolio selected by the user in the configuration system. However, it is also possible to have an account which does not generate any interest or yield whatsoever.

Additionally, the system may look for similar consumer patterns for eventually suggests to the user ways of decreasing unnecessary costs or compulsive spending patterns for example.

From this, one could expect that upon using the system, the savings interest as a percentage of available personal income of the user should increase due to a clearer conscientiousness of expenditures and savings and the possibility of providing money for personal savings investments which is immediately separated through the confirmation of an order on the telephone.

The system can use memory to store in tangible and computer readable media which could include the method of the present invention so that it can be carried out.

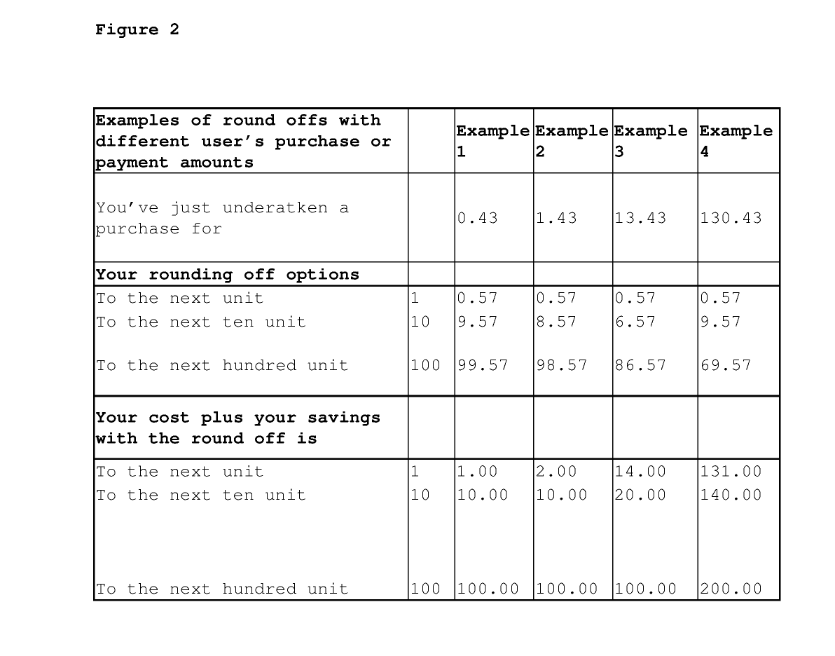

FIG. 2 shows a menu of some of the options to numerically describe the rounding off mechanism.

In this case, four base examples are included, that is, four different product amounts of a first transaction, that is, a purchase or payment undertaken by the user with a merchant and afterwards the different possible round offs are shown depending on the option selected by the user.

Therefore, analyzing example 1, we can see that the user undertakes a first transaction which is 0.43, that is forty-three cents. In this case the user has the option of rounding off to the next unit, to the nearest ten unit or hundred unit, through which, in the first case the secondary transaction would be for 0.57, that is, fifty-seven cents. Through this, the sum of the first transaction plus that of the secondary transaction would be for a total of 1.00 pesos or unit (depending on the appropriate money unit), that is the user would be releasing 1 peso from his/her checking account, of which 0.43 would be applied to the purchase and 0.57 would be credited to his savings or investment account, prior to the respective commissions.

In case the user would choose to round off to the next ten unit, the secondary transaction would be for 9.57 cents (nine pesos and fifty-seven cents) through which he/she would be crediting this amount to his/her savings and his/her total cost would be 10.00 pesos. Lastly, if the selected rounding off were to be the nearest hundred unit, the secondary transaction would be for 99.57 (ninety nine pesos and fifty-seven cents) through which he/she would be crediting this amount to his/her savings prior to commissions and his total cost would be 100.00 pesos.

In the case of Example 2, the user undertakes a first transaction of 1.43, that is, one peso and forty-three cents. In this case, as opposed to example 1, the rounding off amounts or secondary transactions, depending on what unit is selected, the nearest ten or hundred unit would be 0.57, 8.57 and 98.57 through which the user would be incurring costs of 1, 10 or 100 pesos, however the amount of the secondary transactions in rounding off cases to the nearest ten or hundred unit, would be lesser than that in Example 1, as a consequence of there being less units lacking in order to arrive at the sought rounding off unit.

In the case of Example 3, the user undertakes a first transaction of 13.43, that is, thirteen pesos and forty-three cents. Just as is the case in example 2, the rounding off amounts or secondary transactions depending on what unit is selected, the nearest ten or hundred unit would be 0.57, 6.57 and 86.57 through which the user would be incurring costs similar to those in examples 1 and 2 of 1, 10 or 100 pesos, however the amount of the secondary transactions in rounding off cases to the nearest ten or hundred unit, would be lesser than that in Example 1, as a consequence of there being less units lacking in order to arrive at the sought rounding off unit.

Lastly, in example 4 the user undertakes a first transaction of 130.43, that is, one-hundred and thirty pesos and forty-three cents. In this case, the rounding off amounts or secondary transactions depending on what unit is selected, the nearest ten or hundred unit would be 0.57, 9.57 and 69.57 through which the user would be incurring costs similar to those in examples 1, 2 and 3 of 1, 10 or 100 pesos.

In the following Tables 1 and 2 are provided additional examples of the method and system of this invention:

TABLE 1

| | Amount of | | |
|---|---|---|---|
| Concept | receipt | | Total |
| | | Next Unit | |
| | | Round Up | |
| Morning Coffee | 3.80 | 0.20 | 4.00 |
| Groceries | 12.80 | 0.20 | 13.00 |
| Dining | 33.10 | 0.90 | 34.00 |
| Total | 49.70 | 1.30 | 51.00 |
| Savings as % of your spending | | 3% | |
| | | Next Five | |
| | | Round Up | |
| Morning Coffee | 3.80 | 1.20 | 5.00 |
| Groceries | 12.80 | 2.20 | 15.00 |
| Dining | 33.10 | 1.90 | 35.00 |
| Total | 49.70 | 5.30 | 55.00 |
| Savings as % of your spending | | 10% | |
| | | Next Ten | |
| | | Round Up | |
| Morning Coffee | 3.80 | 6.20 | 10.00 |
| Groceries | 11.90 | 8.10 | 20.00 |
| Dining | 33.10 | 6.90 | 40.00 |
| Total | 48.80 | 21.20 | 70.00 |
| Savings as % of your spending | | 30% | |

TABLE 2

| | | | Thousand | Avg. | Annual |
|---|---|---|---|---|---|
| | # of | | of USD | Monthly | Trans- |
| | Cards | $US BI | Yearly | Spending | actions |
| | Millions | (Purchases) | Purchases | Usd | (BI) |
| Credit | | | | | |
| Amex | 52.5 | 424 | 8.08 | 673 | |
| Mastercard | 180 | 534 | 2.97 | 247 | |
| Visa | 278 | 981 | 3.53 | 294 | |
| Total | 458 | 1,939 | 4.23 | 353 | 69 |
| Debit | | | | | |
| Mastercard | 144 | 448 | 3.11 | 259 | |
| Visa | 428 | 1,100 | 2.57 | 214 | |
| Total | 572 | 1,548 | 2.71 | 226 | 41 |
| Credit + Debit | | | | | |
| Total | 1,030 | 3,487 | 3.39 | 282 | 110 |

Source: http://www.creditcards.com/credit-card-news/credit-card-industry-facts-personal-debt-statistics-1276.php

Depending on certain implementation requirements, the ways to undertake the invention can be implemented either on hardware or software. The implementation may be undertaken using a digital storage means, for example a diskette, DVD, CD, ROM memory, PROM, EPROM, EEPROM or FLASH drive, with control signals which are capable of being read electronically having the data stored in them, which cooperate (or are capable of cooperating) with a computer programmable system such that the respective method can be carried out.

Some forms of undertaking according to the invention comprise a data carrier with control signals capable of being electronically read, capable of cooperating with such a computer programmable system which can carry out the described methods.

Another form of undertaking comprises a computer with a computer program installed within, to develop one of the methods described herein.

In some embodiments, a logical programmable device (such as for example a matrix with field programmable gate array) could be used for developing one of the functionalities of the methods described in present invention. In some embodiments, a field programmable gate array could cooperate with a microprocessor with the end goal of developing one of the methods described herein. Generally, all methods are preferably developed by any apparatus or hardware.

Even though various forms of the preferred embodiments of the present invention have been described in detail herein, experts in the field will be able to appreciate that variations to the same can be achieved without departing from the spirit or scope of the invention in the attached claims.

1-18. (canceled)

19. An electronic rounding off method, the method being initiated by an event carried out with a consumer mobile device of a user, the method comprising:
checking if the rounding off operation needs approval from the user;
if approval from the user is needed:
sending to the user an approval notification for selecting and confirming a rounding off order;
receiving the selection and confirmation from the user regarding the rounding off order;
if approval from the user is not needed or if the user selects and confirms the rounding off order:
sending the rounding off approval to an emitter of the consumer mobile device; and
receiving approval or rejection of the rounding off of the emitter of the consumer mobile device.

20. The method according to claim 19, wherein the method additionally comprises registering the user with information including name, address, manner of contacting, data of at least one consumer mobile device, and at least one number and password for one account of the user, wherein the account of the user can be a savings account or an investment account.

21. The method according to claim 20, wherein the account is a pre-existing account or an account assigned by the bank.

22. The method according to claim 19, wherein the electronic method is carried out by an electronic mobile device of a user.

23. The method according to claim 19, wherein if the emitter rejects the rounding off order, the method comprises:
asking the user to select and confirm a rounding off order; and
receiving the selection and confirmation of the rounding off order on behalf of the user.

24. The method according to claim 19, wherein the user pre-selects a fixed amount, variable amount or an amount as a percentage for each possible rounding off category, wherein the variable amount can be depending on a unit, a unit of ten or a hundred unit to be rounded off.

25. The method according to claim 19, wherein if the emitter of the consumer mobile device approves the rounding off, the method additionally comprises:
sending a rounded off amount to an account of the user; and
crediting the rounded off amount to the account of the user.

26. The method according to claim 25, wherein the rounded off amount is sent in real time, in a weekly manner, monthly manner, after a set period of time selected by the user has lapsed, by specific orders of the user, or a number of events has passed.

27. The method according to claim 19, wherein if the emitter approves the rounding off, the method additionally comprises sending a notification to a user's electronic mobile device informing a balance of the user including the rounding off approved by the emitter.

28. The method according to claim 19, wherein the approval for selecting and confirming the rounding off order is sent to an electronic mobile device of the user and wherein the selection and confirmation on the part of the user regarding the rounding off order is received in the electronic mobile device of the user.

29. The method according to claim 19, wherein the method further comprises reading an event confirmation message sent by the emitter of the consumer mobile device.

30. The method according to claim 19, wherein the method further comprises being connected to an Application Programming Interface to confirm the event.

31. The method according to claim 19, wherein when the rounded off approval from the emitter of the consumer mobile device is received, the method further comprises checking if the event is performed in establishments wherein the user has a fixed discount for sending the equivalent of the fixed discount to a savings account of the user.

32. A non-transitory computer-readable data storage device comprising a computer program product according to claim 1.

33. A rounding off method undertaken in an electronic mobile device of a user, the method initiated by an event undertaken in an electronic mobile device of a user, the method comprising:
receiving an approval order in the electronic mobile device for selecting and confirming a rounding off order;
sending from the electronic mobile device the selection and confirmation on behalf of the user regarding the rounding off order;
receiving in the electronic mobile device a notification of a balance including the approved rounding off.

34. A method to round off an amount of a purchase or a payment undertaken with an electronic mobile device of a user to the next unit, ten unit or hundred unit, etc. the method comprising:
sending an electronic request so that the user selects a rounded off amount;
receiving the electronic request including the rounded off amount;
charging to the electronic mobile device of the user the rounded off amount; and
sending an electronic notification to the user confirming the rounded off amount and the charge to the electronic mobile device of the user.

35. A system for rounding off an amount of an event, the system comprising:
a consumer mobile device whose use activates the event;
an electronic system capable of establishing communication;
a processor which checks on a memory whether the rounding off needs approval from the user;
a means of communication with the electronic system, the means of communication capable of:
sending to the user an electronic approval for selecting and confirming a rounding off order;
receiving the selection and confirmation on behalf of the user regarding the rounding off order;
sending an electronic rounding off approval order to an emitter of the consumer mobile device; and
receiving an approval or rejection of the rounding off from the emitter of the consumer mobile device.

36. The system according to claim 35, wherein the user pre-selects a fixed amount, variable amount or an amount as a percentage for each possible rounding off category, wherein the variable amount can be depending on a unit, a unit of ten or a hundred unit to be rounded off.
